(19) United States
(12) Patent Application Publication
(10) Pub. No.: US 2021/0120859 A1
(43) Pub. Date: Apr. 29, 2021

(54) FORTIFIED PLANT-BASED FORMULATIONS

(71) Applicant: iVolution Organic Whole Foods Inc., Terrebonne (CA)

(72) Inventors: Delphine BOILLOT, Saint-Bruno-de-Montarville (CA); Christian MARINARO, Saint-Bruno-de-Montarville (CA)

(21) Appl. No.: 16/927,442

(22) Filed: Jul. 13, 2020

Related U.S. Application Data
(60) Provisional application No. 62/924,764, filed on Oct. 23, 2019.

(51) Int. Cl. A23L 33/00; A23L 33/15; A23L 33/12; A23L 33/105

(52) U.S. Cl. CPC A23L 33/40; A23L 33/105; A23L 33/12; A23L 33/15

(57) ABSTRACT

The present technology relates to a fortified plant-based formulation suitable for administration to a subject. The fortified plant-based formulation comprises, at least one vitamin component; at least one lipid component; at least one protein component; and at least one calcium-source component, wherein the at least one calcium-source component is an algae, and is present in the fortified plant-based formulation in an amount ranging from between about 0.5 to about 4 wt %.

### FIELD OF DISCLOSURE

The present technology generally relates to fortified plant-based formulations suitable for administration to a subject.

### BACKGROUND OF DISCLOSURE

Consumer demand for natural plant-based products has been growing in recent years. Natural products are nowadays perceived as more pure and mild, and thus superior to their synthetic counterparts. Moreover, with increasing popularity of plant-based and vegan diets, as well as increasing diagnosis of cow's milk allergies in children and adults alike, the demand for healthy and natural plant-based alternative beverages to cow's milk and plant-based nutritional supplements has been on the rise.

Plant-based alternatives however are generally considered to be incomplete sources of calcium compared to cow's milk. Calcium is the most common mineral in the human body and is vitally important. Calcium is a major structural constituent of bones in the human skeleton, and plays a significant role in electrophysiological processes, cell signaling, and as a cofactor for extracellular enzymes and regulatory proteins. Although acute deficiency symptoms are rare because of the large skeletal stores, prolonged bone resorption from chronic dietary deficiency can lead to osteoporosis in later stages of life as a result of inadequate accumulation of bone mass during normal growth and development. Dietary calcium deficiency is also associated with an increased risk of hypertension, preeclampsia, and colon cancer in adults. Furthermore, bone density also determines fracture risk in children. As such, adequate intake of calcium is essential in children, to ensure healthy growth and development, and to prevent diseases and conditions in later stages of life.

Therefore, there is a need for fortified plant-based formulations for children which comprise calcium as a major constituent and provide the essential nutrients required for healthy growth.

### SUMMARY

In various aspects, the present technology relates to a fortified plant-based formulation suitable for administration to a subject. The fortified plant-based formulation comprises, at least one vitamin component; at least one lipid component; at least one protein component; and at least one calcium-source component. In some instances, the calcium-source component is an algae and is present in the fortified plant-based formulation in an amount ranging from between about 0.5 to about 4 wt %.

In other aspects, the present technology relates to a method for providing a nutritional supplement to a subject. The method comprises feeding said fortified plant-based formulation to the subject.

Other aspects and features of the present disclosure will become apparent to those ordinarily skilled in the art upon review of the following description of specific embodiments.

### DETAILED DESCRIPTION

The present disclosure is not limited in its application to the details of construction and the arrangement of components set forth in the following description or illustrated in the drawings. The disclosure is capable of other embodiments and of being practiced or of being carried out in various ways. Also, the phraseology and terminology used herein is for the purpose of description and should not be regarded as limiting.

The use of “including”, “comprising”, or “having”, “containing”, “involving” and variations thereof herein, is meant to encompass the items listed thereafter as well as, optionally, additional items. In the following description, the same numerical references refer to similar elements.

It must be noted that, as used in this specification and the appended claims, the singular form “a”, “an” and “the” include plural referents unless the context clearly dictates otherwise.

As used herein, the term “about” in the context of a given value or range refers to a value or range that is within 20%, preferably within 10%, and more preferably within 5% of the given value or range.

As used herein, the term “and/or” is to be taken as specific disclosure of each of the two specified features or components with or without the other. For example “A and/or B” is to be taken as specific disclosure of each of (i) A, (ii) B and (iii) A and B, just as if each is set out individually herein.

The recitation herein of numerical ranges by endpoints is intended to include all numbers subsumed within that range (e.g., a recitation of 1 to 5 includes 1, 1.25, 1.33, 1.5, 2, 2.75, 3, 3.80, 4, 4.32, and 5).

As used herein, the terms “formulation” refers to a composition of matter.

As used herein, the term “natural” or “naturally occurring” refers to what is found in nature.

As used herein, the expression “plant-based formulation” refers to a formulation comprising foods derived from plants, including vegetables, grains, nuts, seeds, legumes and fruits, and with few or no animal and/or synthetic products.

As used herein, the expression “nutritional supplement” refers to food supplements used to boost the nutritional content of a diet. They can be added to a diet to support growth, boost overall health and energy; to provide immune system support and reduce the risks of illness and age-related conditions; to improve performance in athletic and mental activities; and to support healing process during illness and disease.

As used herein, the expression “marine calcium” refers to calcium-source components derived from algae that spend a significant portion of their life cycle in a marine environment.

As used herein, the term “algae” refers to a non-flowering, stem less, water plant.

Broadly, the present technology relates to a fortified plant-based formulation suitable for administration to a subject. The fortified plant-based formulation of the present technology comprises at least one vitamin component, at least one lipid component; at least one protein component; and at least one calcium-source component comprising algae. The formulation of the present technology is designed to provide a healthy, balanced, and natural alternative to cow's milk as a beverage or nutritional supplement suitable for administration to subjects and in particular to children that is allergen-free and contains all the essential nutrients required for healthy growth.

Children have been divided into specific age-groups in the field of pediatric to account for the many complex and interacting biological, developmental, psychological, and social changes that occur from their birth to adulthood. Age groups are commonly used in analysis of population health, education, clinical care, research, including development of nutritional formulations. Currently, the age group standards for pediatric trials defined according to the National Institute of Child Health and Human Development are as follows: preterm neonatal (the period at birth when a newborn is born before the full gestational period); term neonatal (birth to 27 days old); infancy (28 days old to 12 months old); toddler (13 months old to 24 months old); early childhood (24 months old to 5 years old); middle childhood (6 to 11 years old); early adolescence (12 to 18 years old); and late adolescence (19 to 21 years old), following which adulthood is considered to begin (21 years old and older).

In some embodiments, the formulation of the present technology is suitable for administration to children between the ages of birth to full gestation, between birth to about 27 days old, between about 28 days old to about 12 months old, between about 13 months old to about 24 months old , between about 24 months old to about 5 years old, between about 6 years old to about 11 years old, between about 12 years old to about 18 years old, or between about 19 years old to about 21 years old.

In other embodiments, the formulation of the present technology is suitable administration to children in multiple age groups. For example the formulation of the present technology may be suitable for administration to children between the ages of about 6 months old to about 12 months old, between about 12 months old to about 24 months old, or between the ages of about 24 months old and older.

In yet other embodiments the formulation of the present technology is suitable for administration to adults between the ages of about 21 years old and older. In some implementations of this embodiment the adult is undergoing physical exercise or physical training (e.g., athlete). In other implementations of this embodiment, the adult is a woman breastfeeding a child. In yet other implementations of this embodiment, the adult is a pregnant woman.

Calcium-Source Component

In one embodiment, the formulation of the present technology comprises at least one calcium-source component. In some implementations, the calcium-source component is an algae. Calcium-source components derived from algae are also known as marine calcium. In comparison to existing calcium supplements which generally consist of calcium carbonate or calcium citrate derived from rocks, calcium-source components derived from algae are more easily digested and absorbed by the human body, and further include vitamin D3 and vitamin K2 which enhance calcium absorption by the bones; as such, they are considered to be advantageous over the latter when consumed.

In some implementations of this embodiment, the algae is red algae. In some instances, the red algae is of the class Rhodophyceae. In yet other instances, the Rhodophyceae is of the order Corallinale. In further implementations, the Corallinale is a non-geniculate Coralline algae. In yet further implementations, the non-geniculate Coralline algae is any one or more of a rhodolith algae. In a preferred embodiment, the rhodolith algae is any one or more of Phymatolithon calcareum and Lithothamnium corrallioides.

In other embodiments, the at least one calcium-source component further comprises natural magnesium derived from algae. Magnesium is essential for bone fortification, deposition and utilization of minerals in the human body. Furthermore, magnesium is also an electrolyte contributing to hydration and sustenance of other important bodily functions including muscle contraction and transmission of nerve impulses.

In some embodiments, the at least one calcium-source component is present in the fortified plant-based formulation in an amount ranging from between about 0.5 to about 4.0 wt %, between about 0.5 to about 3.5 wt %, between about 0.5 to about 3.0 wt %, between about 0.5 to about 2.5 wt %, between about 0.5 to about 2.0 wt %, between about 0.5 to about 1.5 wt %, between about 0.5 to about 1.0 wt %, between about 1.0 to about 4.0 wt %, between about 1.0 to about 3.5 wt %, between about 1.0 to about 3.0 wt %, between about 1.0 to about 2.5 wt %, between about 1.0 to about 2.0 wt %, between about 1.0 to about 1.5 wt %, between about 1.5 to about 4 wt %, between about 1.5 to about 3.5 wt %, between about 1.5 to about 3.0 wt %, between about 1.5 to about 2.5 wt %, between about 1.5 to about 2.0 wt %, between about 2.0 to about 4.0 wt %, between about 2.0 to about 3.5 wt %, between about 2.0 to about 3.0 wt %, between about 2.0 to about 2.5 wt %, between about 2.5 to about 4.0 wt %, between about 2.5 to about 3.5 wt %, between about 2.5 to about 3.0 wt %, between about 3.0 to about 4.0 wt %, between about 3.0 to about 3.5 wt %, or between about 3.5 to about 4.0 wt % of the total weight of the formulation.

Vitamin Component

The formulation of the present technology comprises at least one vitamin component. A vitamin is an organic molecule that is an essential micronutrient that an organism needs in small quantities for the proper functioning of its metabolism. Vitamins are essential for the normal growth and development of children. Deficiencies in one or more of vitamins may lead to the development of deficiency disease and cause permanent damage. In adults also, vitamins are essential for the healthy maintenance of cells, tissues and organs. In humans, essential vitamins are either synthesized in insufficient quantities or cannot be synthesized by innate metabolic processes. As such, they must be obtained through the diet.

As molecules, vitamins are classified as lipid soluble vitamins or water soluble vitamins Non-limiting examples of vitamin components include biotin (or vitamin B7), riboflavin (or vitamin B2), thiamin (or vitamin B1), vitamin A, vitamin B-12, vitamin B-6, vitamin C, vitamin D, vitamin E, vitamin K, niacin (or vitamin B3), folate (or vitamin B9) , and pantothenate (or vitamin B5).

In some embodiments, the vitamin component is present in the formulation of the present technology in an amount ranging between about 0.02 and about 0.1 wt %, between about 0.03 and about 0.1 wt %, between about 0.04 and about 0.1 wt %, between about 0.05 and about 0.1 wt %, between about 0.06 and about 0.1 wt %, between about 0.07 and about 0.1 wt %, between about 0.08 and about 0.1 wt %, between about 0.09 and about 0.1 wt %, between about 0.02 and about 0.09 wt %, between about 0.03 and about 0.09 wt %, between about 0.04 and about 0.09 wt %, between about 0.05 and about 0.09 wt %, between about 0.06 and about 0.09 wt %, between about 0.07 and about 0.09 wt %, between about 0.08 and about 0.09 wt %, between about 0.08 and about 0.09 wt %, between about 0.02 and about0.08 wt %, 0.08 wt %, between about 0.03 and about 0.08 wt %, between about 0.04 and about 0.08 wt %, between about 0.05 and about 0.08 wt %, between about 0.06 and about 0.08 wt %, between about 0.07 and about 0.08 wt %, between about 0.02 and about 0.07 wt %, between about 0.03and about 0.07 wt %, between about 0.04 and about 0.07 wt %, between about 0.05 and about 0.07 wt %, between about 0.06 and about 0.7 wt %, between about 0.02 and about 0.06 wt %, between about 0.03 and about 0.06 wt %, between about 0.04 and about 0.06 wt %, between about 0.05 and about 0.06 wt %, between about 0.02 and about 0.05 wt %, between about 0.03 and about 0.05 wt %, between about 0.04 and about 0.05 wt %, between about 0.02 and about 0.04 wt %, between about 0.03 and about 0.04 wt %, or between about 0.02 and about 0.03 wt % of the total weight of the formulation.

Lipid Component

The formulation of the present technology also comprises at least one lipid component. Lipids are essential components of a complete diet as they serve as structural building materials of cell membranes and organelles, provide energy to the organism and function as molecular messengers and signaling molecules in the body of the human. Furthermore, lipids are critical for the sensory characteristics of food products for the mouthfeel and consistency, and can influence the flavors and/or aroma of food products.

In some embodiments, the lipid component of the formulation of the present technology can be selected for example from plant-based fats, oils, glycerides, phospholipids, and free fatty acids.

Non-limiting examples of oils suitable for the formulation of the present technology comprise sunflower oil, coconut oil, mustard oil, peanut oil, canola oil, corn oil, cottonseed oil, flax seed oil, golden flax seeds, olive oil, palm oil, rapeseed oil, safflower oil, sesame oil, soybean oil, almond oil, beech nut oil, brazil nut oil, cashew oil, hazelnut oil, macadamia nut oil, mongongo nut oil, pecan oil, pine nut oil, pistachio nut oil, walnut oil, avocado oil, grape oil, algae-derived oils, fungus-derived oils, non-essential oils, essential oils, natural oils, non-hydrogenated oils, partially hydrogenated oils, hydrogenated oils (e.g., hydrogenated coconut oil), crude oils, semi-refined (also called alkaline refined) oils, and refined oils. In some embodiments, longer chain oils (e.g., sunflower oil, corn oil, olive oil, soy oil, peanut oil, walnut oil, almond oil, sesame oil, cottonseed oil, canola oil, safflower oil. flax seed oil, palm oil, palm kernel oil, palm fruit oil, coconut oil, babassu oil, shea butter, mango butter, cocoa butter, wheat germ oil, rice bran oil, engineered sunflower oil that overexpresses oleic acid by 400%) are combined with short-chain triglycerides to produce transesterified fatty acid esters. Various combinations of triglycerides and longer chain oils can be incorporated to create a number of different flavor profiles.

Glycerides comprise the mono-, di- and triglycerides family of lipids. Non-limiting examples of plant-derived monoglycerides and diglycerides suitable for the formulation of the present technology include those derived from sunflower, coconut, peanut, cottonseed, olive, palm, rapeseed, safflower, sesame seed, soybean, almond, beech nut, Brazil nut, cashew, hazelnut, macadameia nut, mongongo nut, pecan, pine nut, pistachio, walnut, and avocado. The monoglycerides and diglycerides can include the acyl chain of any of the free fatty acids listed herein. Non-limiting examples of triglycerides include tributyrin, short-chain triglycerides, short-chain triglycerides comprising three oleic acids; hexanoic acid; hexanoic acid and butyric acid; hexanoic acid and decanoic acid; one butyric, one hexanoic, and one octanoic acid. Additional examples of monoglycerides, diglycerides and triglycerides are known in the art.

Non-limiting examples of free fatty acids suitable for the formulation of the present technology include butyric acid, caproic acid, caprylic acid, capric acid, lauric acid. myristic acid, palmitic acid, stearic acid, arachidic acid, behenic acid, lignoceric acid, cerotic acid, myristoleic acid, pamitoleic acid, sapienic acid, oleic acid, elaidic acid, vaccenic acid, linoleic acid, linoelaidic acid, a-linolenic acid, arachidonic acid, eicosapentaenoic acid, erucic acid, Docosahexaenoic acid, omega-fatty acids (e.g., arachidonic acid, omega-3-fatty acids, omega-6-fatty acids, omega-7-fatty acids, omega-9-fatty acids), fatty acids with even number of carbons of 4-16 carbons in length, monosaturated, saturated, unsaturated and monounsaturated fatty acids. Unsaturated fatty acids include three major classes, the omega-3, omega 6 and omega-9 fatty acids. Omega-6 and omega-3 fatty acids are considered to be essential as they are required for the proper structure and functioning of every cell of the human body, and must be obtained through the diet as the body cannot make them. Furthermore, essential fatty acids also increase the absorption of vitamins and minerals. As such, it is advantageous for them to be present in fortified plant-based formulations to ensure proper absorption and maximization of the benefits of such formulations upon consumption.

Non-limiting examples of phospholipids suitable for the formulation of the present technology include lecithin phospholipids from soy, sunflower, cotton, rapeseed, rice bran, and corn. Lecithin phospholipids include, but are not limited to cardiolipin, ceramide phosphocholines, ceramide phosphoethanolamines, glycerophospholipids, phasphatidicacid, phosphatidylcholine, phosphatidylethanolamine, phosphatidylinositol, phosphospingolipids, and phsophatidylserine. In some embodiments, the phospholipids are not derived from or produced by animals. Additional aspects of phospholipids are known in the art.

In some embodiments, the lipid component is present, in the formulation of the present technology, in an amount ranging between about 5 and about 35 wt %, between about 5 and about 30 wt %, between about 5 and about 25 wt %, between about 5 and about 20 wt %, between about 5 and about 15 wt %, between about 5 and about 10 wt %, between about 10 and about 35 wt %, between about 10 and about 30 wt %, between about 10 and about 25 wt %, between about 10 and about 20 wt %, between about 10 and about 15 wt %, between about 15 and about 35 wt %, between about 15 and about 30 wt %, between about 15 and about 25 wt %, between about 15 and about 20 wt %, between about 20 and about 35 wt %, between about 20 and about 30 wt %, between about 20 and about 25 wt %, between about 25 and about 35 wt %, between about 25 and about 30 wt %, or between about 30 and about 35 wt %, of the total weight of the formulation.

Protein Component

The formulation of the present technology further comprises at least one protein component. Proteins are also essential for the growth and sustenance of the human body. In children, protein is vital for normal growth and development. The most important aspect and defining characteristic of proteins from a nutritional standpoint is their amino acid composition. Out of twenty amino acids, nine are essential since they cannot be synthesized by the body and as such must be provided by the diet. The essential amino acids include phenylalanine, valine, threonine, tryptophan, methionine, leucine, isoleucine, lysine, and histidine. Insufficient protein intake in children results in health issues including fatigue, poor concentration, slowed growth, bone and joint pain, delayed wound healing and decreased immune response.

In some embodiments, the formulation of the present technology comprises any one or more amino acid comprising aspartic acid, threonine, serine, glutamic acid, glycine, alanine, valine, methionine, isoleucine, leucine, tyrosine, phenylalanine, lysine, histidine, arginine, proline, hydroxyproline, cystein, and tryptophonan. In further embodiments, the formulation of the present technology comprises all essential amino acids.

In one embodiment, the protein component suitable for the formulation of the present technology may be derived from any one or more of non-animal sources. Non-limiting examples of non-animal protein sources suitable for the formulation of the present technology include plants, algae, fungi or microbes sources.

Non-limiting examples of plant protein sources suitable for the formulation of the present technology include but are not limited to spermatophytes (spermatophyta), acrogymnospermae, angiosperms (magnoliophyta), ginkgoidae, pinidae, mesangiospermae, cycads, Ginkgo, conifers, gnetophytes, ginkgo biloba, cypress, junipers, thuja, cedarwood, pines, angelica, caraway, coriander, cumin, fennel, parsley, dill, dandelion, helichrysum, marigold, mugwort, safflower, chamomile, lettuce, wormwood, calendula, citronella, sages, thyme, chia seed, mustard, olive, coffee, capsicum, eggplant, paprika, cranberry, kiwi, vegetable plants (e.g., carrot, celery), tagetes, tansy, tarragon, sunflower, wintergreen, basil, hyssop, lavender, lemon verbena, marjoram, melissa, patchouli, pennyroyal, peppermint, rosemary, sesame, spearmint, primroses, samara, pepper, pimento, potato, sweet potato, tomato, blueberry, nightshades, petunia, morning glory, lilac, jasmin, honeysuckle, snapdragon, psyllium, wormseed, buckwheat, amaranth, chard, quinoa, spinach, rhubarb, jojoba, cypselea, chlorella, manila, hazelnut, canola, kale, bok choy, rutabaga, frankincense, myrrh, elemi, hemp, hemp hearts, pumpkin, pumpkin seed, squash, curcurbit, manioc, dalbergia, or legume plants including alfalfa, lentils, beans, clovers, peas, fava coceira, frijole bola roja. frijole negro, lespedeza, licorice, lupin, mesquite, carob, soybean, peanut, tamarind, wisteria, cassia, chickpea, garbanzo, fenugreek, green pea, yellow pea, snow pea, lima bean, fava bean), geranium, flax, pomegranate, cotton, okra, neem, fig, mulberry, clove, eucalyptus, tea tree, niaouli, fruiting plants (e.g., apple, apricot, peach, plum, pear, nectarine), strawberry, blackberry, raspberry, cherry, prune, rose. tangerine, citrus (e.g., grapefruit, lemon, lime, orange, bitter orange, mandarin), mango, citrus bergamot, buchu, grape, broccoli, brussels, sprout, camelina, cauliflower, rape, rapeseed (canola), turnip, cabbage, cucumber, watermelon, honeydew melon, zucchini, birch, walnut, cassava, baobab, allspice, almond, breadfruit, sandalwood, macadamia, taro, tuberose, aloe vera, garlic, onion, shallot, vanilla, yucca, vetiver, galangal, barley, corn, curcuma aromatica, ginger, lemon grass, oat, palm, pineapple, rice, rye, sorghum. triticale, turmeric, yam, bamboo, barley, cajuput, canna, cardamom, maize, oat, wheat, cinnamon, sassafras, lindera benzoin, bay laurel, avocado, ylang-ylang, mace, nutmeg, moringa, horsetail, oregano, cilantro, chervil, chive, aggregate fruits, grain plants, herbal plants, leafy vegetables, non-grain legume plants, nut plants, succulent plants, land plants, water plants, delbergia, millets, drupes, schizocarps, flowering plants, non-flowering plants, cultured plants, wild plants, trees, shrubs, flowers. grasses, herbaceous plants, brushes, lianas, cacti, green algae, tropical plants, subtropical plants, temperate plants, and derivatives and crosses thereof.

Non-limiting examples of algae protein sources suitable for the formulation of the present technology include but are not limited to green algae (e.g., Chlorella), brown algae (e.g., Alaria marginata, Analipus japonicus, Ascophyllum nodosum, Ecldonia sp, Eisenia bicyclis, Hizikia fitsiforme, Kjellmaniella gyrata, Laminaria angustata, Laminaria longirruris, Laminaria Longissima, Laminaria ochotensis, Laminaria claustonia, Laminaria saccharina, Laminaria digitata, Laminaria japonica, Macrocystis pyrifera, Petalonia fascia, Scytosiphon tome), red algae (e.g., Phymatolithon calcareum, Lithothamnium corrallioides, Gigartinaceae, Soliericeae, Chondrus crispus, Chondrus ocellatus, Eucheuma cottonii, Eucheuma spinosum, Furcellaria fastigiata, Gracilaria bursa-pastoris, Gracilaria lichenoides, Gloiopeltis furcata, Gigartina acicularis, Gigartina bursa-pastoris, Gigartina pistillata, Gigartina radula, Gigartina skottsbergii, Gigartina stellata, Palmaria palmata, Porphyra columbina, Porphyra crispata, Porhyra deutata, Porhyra perforata, Porhyra suborbiculata, Porphyra tenera, Porphyridium cruentum, Porphyridium purpureum, Porphyridium aerugineum, Rhodella maculate, Rhodella reticulata, Rhodella violacea, Rhodophyceae, Rhodymenia palmata), and derivatives and crosses thereof.

In some embodiments, the protein component is present in the formulation of the present technology in an amount ranging from between about 10 and about 50 wt %, between about 10 and about 45 wt %, between about 10 and about 40 wt %, between about 10 and about 35 wt %, between about 10 and about 30 wt %, between about 10 and about 25 wt %, between about 10 and about 20 wt %, between about 10 and about 15 wt %, between about 15 and about 50 wt %, between about 15 and about 45 wt %, between about 15 and about 40 wt %, between about 15 and about 35 wt %, between about 15 and about 30 wt %, between about 15 and about 25 wt %, between about 15 and about 20 wt %, between about 20 and about 50 wt %, between about 20 and about 45 wt %, between about 20 and about 40 wt %, between about 20 and about 35 wt %, between about 25 and about 50 wt %, between about 25 and about 45 wt %, between about 25 and about 40 wt %, between about 25 and about 35 wt %, between about 25 and about 30 wt %, between about 30 and about 50 wt %, between about 30 and about 45 wt %, between about 30 and about 40 wt %, between about 30 and about 35 wt %, between about 35and about 50 wt %, between about 35 and about 45 wt %, between about 35 and about 40 wt %, between about 40 and about 50 wt %, between about 40 and about 45 wt %, or between about 45 and about 50 wt % of the total weight of the formulation.

Additional Components
i) Carbohydrate Component

In some embodiment, the formulation of the present technology further comprises at least one carbohydrate component. Carbohydrates provide sweetness to the taste profiles and/or serve as fast-acting energy and nutrition sources.

Carbohydrates are generally classified by the number of sugar units in their structures as monosaccharides, disaccharides, oligosaccharides, and polysaccharides. The carbohydrates of the present technology may include any that are used in the food industry. Non-limiting examples of carbohydrates include: glucose, glucose polymers, dextrose, maltose, maltodextrin, maltrotiose, lactose, galactose, sucrose, sucanat, arabinose, ribose, xylose, fructose, levulose, psicose, sorbose, tagose, and sorbitol, and combinations thereof.

Fiber, and more specifically dietary fiber, is also a carbohydrate. Fibers are within the class of polysaccharides, and are carbohydrates that cannot be digested. Fiber is present in most plants that are eaten for food, such as fruits, vegetables, grains, and legumes. The consumption of fiber in daily diet has been shown to increase various aspects of health, including: reducing the risk of heart disease, reducing the risk of type 2 diabetes, reducing the risk of diverticular disease, and reducing constipation. Although it is recommended that dietary fiber be increased gradually in childhood by increasing consumption of a variety of fruits, vegetables, legumes, cereals, and other whole-grain products, studies demonstrate that dietary fiber provides similar benefits for children as for adults.

In one embodiments, the carbohydrates component of the formulation of the present technology is for example, refined sugar, brown sugar, molasses, corn syrup, maple syrup, maple sugar, fruit juices, fruit syrups, fruit vegetable and seed blends, banana powder, rice milk powder, fermented rice powder, hemp hearts powder, quinoa sprouts, and other commercially available carbohydrates components. in some implementations of this embodiment, the fruits and vegetables used as carbohydrates components may be from an organically grown source.

In some embodiments the at least one carbohydrate component is present in the fortified plant-based formulation in an amount ranging from between about 20 to about 60 wt %, between about 20 to about 55 wt %, between about 20 to about 50 wt %, between about 20 to about 45 wt %, between about 20 to about 40 wt %, between about 20 to about 35 wt %, between about 20 to about 30 wt %, between about 20 to about 25 wt %, between about 25 to about 60 wt %, between about 25 to about 55 wt %, between about 25 to about 50 wt %, between about 25 to about 45 wt %, between about 25 to about 40 wt %, between about 25 to about 35 wt %, between about 25 to about 30 wt %, between about 30 to about 60 wt %, between about 30 to about 55 wt %, between about 30 to about 50 wt %, between about 30 to about 45 wt %, between about 30 to about 40 wt %, between about 30 to about 35 wt %, between about 35 to about 60 wt %, between about 35 to about 55 wt %, between about 35 to about 50 wt %, between about 35 to about 45 wt %, between about 35 to about 40 wt %, between about 40 to about 60 wt %, between about 40 to about 55 wt %, between about 40 to about 50 wt %, between about 40 to about 45 wt %, between about 45 to about 60 wt %, between about 45 to about 55 wt %, between about 45 to about 50 wt %, between about 50 to about 60 wt %, between about 50 to about 55 wt %, or between about 55 to about 60 wt % of the total weight of the formulation.
ii) Minerals

In some embodiments, the formulation of the present technology may also comprise minerals. Minerals serve a wide variety of essential physiological functions ranging from structural components of body tissues to essential components of many enzymes and other biological important molecules. As such, they are an essential component of a nutritionally complete diet. Non-limiting examples of minerals suitable for the formulation of the present technology include copper, iron, magnesium, silver, gold, manganese, phosphorus, potassium, selenium, sodium, zinc, iodine, chloride, chromium, molybdenum, and the like. The minerals may be inherently present in the ingredients used in the formulation of the present technology, or may be added in the form of salts such as pink, and/or seas alt, as well as other known natural mineral and electrolyte sources such as coconut water powder and the like.
iii) Additives

The formulation of the present technology may also include at least one emulsifier. Any emulsifiers capable of being used in the art of foods may be used. Emulsifiers may be needed when ingredients in the formulation do not dissolve. For example, some lipids may not dissolve in water-based formulations. in the presence of emulsifiers these non-soluble components may become substantially evenly disbursed throughout the formulation instead of collecting at a common location within the suspension. Non-limiting examples of emulsifiers suitable for the formulation of the present technology include acacia gum and the like.

Other additional components that may be suitable for use in the formulation of the present technology include coloring agents, color enhancers, and color stabilizers (e.g., titanium oxide). Furthermore the formulation of the present technology may include taste agents, taste enhancers, and taste stabilizers (e.g., b-decalactone, ethyl butyrate, 2-furyl methyl ketone, 2,3-pentanedione, y-undecalactone, 8-undecalactone, natural organic or non organic flavors (e.g. cocoa powder, coconut milk powder, green tea, cherry powder, sour cheery, apple kale, bocoli, spinach, carrot, parsley, beet root, green cabbage, blueberry, raspberry, strawberry, tomato, pumpkin, sweet potato, sunflower seed, kelp, Chlorella, Maitake and Shiitake mushroom powders and blends), artificial flavors [e.g., chocolate, coffee, strawberry, almond, hazelnut, vanilla, green tea, Irish cream, coconut flavoring], triglycerides, hydrolyzed casein or whey protein), and thickening agents (e.g., guar gum, pectin).

In some embodiments, the formulation of the present technology may also comprise sweetening agents. Non-limiting examples of sweetening agents suitable for the formulation of the present technology include but are not limited to stevia, aspartame, cyclamate, saccharin, sucralose, mogrosides, brazzein, curculin, erythritol, glycyrrhizin, inulin, isomalt, lacititol, mabinlin, malititol, mannitol, miraculin, nionatin, monelin, osladin, pentadin, sorbitol, thaumatin, xylitol, acesulfame potassium, advantame, alitame, aspartame-acesulfame, sodium cyclamate, dulcin, glucan, neohesperidin dihyrdochalcone, neotame, and P-4000). In some implementations of these embodiments, the sweetening agents do not comprise carbohydrates.

Other components suitable for use in the formulation of the present technology include natural medicinal ingredients and supplements including, but not limited to, spirulina, medicinal mushrooms, ginseng, green tea, matcha, ashwagandha, astragalus, moringa, dandelion, beet root, medicinal mushrooms mycelial biomass blends and the like.

Further non-limiting examples of additional components suitable for the formulation of the present technology include aroma agents, aroma stabilizers, and aroma enhancers (e.g., propylene glycol, glycerol, ethyl alcohol, salt, sugars), shelf life extending agents (e.g., carbon monoxide, nitrites, sodium metabisulfite, Bombal, vitamin E, rosemary extract, green tea extract, catechins, antioxidants), anti-caking agents, anti-foaming agents, anti-inflammatory agents, anti-microbial agents, anti-oxidants, buffering agents, clotting agents, coenzymes, enzymes, neutraceuticals, nutritional supplements, pH and/or ionic strength adjusting agents, prebiotics, and probiotic cultures.

Method of Administration

From another aspect, the present technology is related to a method for providing a nutritional supplement to a subject. The method comprises feeding the fortified plant-based.

formulation of the present technology to the subject. In some implementations, the method comprises feeding the fortified plant-based formulation of the present technology to a child. In some instances, the child is between 6 months old to about 12 months old. In other instances, the child is between about 12 months old to about 24 months old. In yet other instances, the child is between about 24 months old and older. In other implementations, the method comprises feeding the fortified plant-based formulation of the present technology to an adult. In some instances the adult is between the ages of about 21 years old and older. In other instances, the adult is undergoing physical exercise or physical training (e.g., athlete). In yet other instances, the adult is a woman breastfeeding a child or a pregnant woman.

In one embodiment, the formulation may be provided in any suitable oral consumption form, including for example tablets, powders, granules, beads, chewable lozenges, capsules, aqueous suspensions or solutions, other liquid forms, or similar conventional dosage forms, using conventional equipment and techniques known in the art. Since liquid or suspension forms are preferable in young children, the formulation of the present technology may be in any liquid form suitable for consumption, or suitable for dissolving, combining, or diluting, including, for example, dehydrated, ready-to-consume or concentrated forms in some implementations. The concentrated forms may include liquid concentrated forms, and substantially dehydrated concentrated forms. In further implementations of the embodiment, the formulation of the present technology is in a dehydrated form. Both liquid concentrated and dehydrated forms require that a diluting agent be added to the concentrate before it is ready to consume. The liquid concentrate has the advantage that less diluting agent need to be added for consumption, and complete dissolution of the concentrate in the diluting agent is more probable than with the substantially dehydrated form. The liquid concentrate, however, is more expensive to transport, creates more waste, and typically has a shorter shelf life than the substantially dehydrated form.

The dehydrated form of the formulation of the present technology may be made by dehydrating methods known in the food arts. Some examples of dehydrating methods include vacuum drying, freeze drying, spray drying, and the like. The dehydrated formulation may be in the form of a powder, grains, flakes, pellets, or the like. Dehydrated formulations have the advantage of being lighter, less expensive and easier to ship, typically have a longer shelf life, create less waste, and typically have a longer period between the time they are opened and the time they spoil or degrade. Unlike the ready-to-consume and liquid concentrate, dehydrated formulations typically have a longer shelf life after being opened and can thus be sold in bulk form to provide many servings. However, dehydrated formulations may also be packaged in single-use servings and the like for different purposes.

Dehydrated and concentrated forms of the formulation of the present technology may be diluted with any diluting agent known in the art of foods. The diluting agent may include, for example, water, milk, plant-based milk alternatives such as almond, soy, coconut, rice, and oat milk and the like, fruit juice, vegetable juice, fruit extracts, vegetable extracts, and the like. Fruit and vegetable extracts may include, for example, a fruit or vegetable stock which may be made by cooking a fruit and/or vegetable in water, and then removing the fruit and/or vegetable from the liquid. Further, the diluting agent may be a fortified diluting agent.

In some embodiments, the dehydrated form of the formulation of the present technology may be diluted to a concentration of between about 100 g/L to about 200 g/L, between about 100 g/L to about 180 g/L, between about 100 g/L to about 160 g/L, between about 100 g/L to about 140 g/L, between about 100 g/L to about 120 g/L, between about 120 g/L to about 200 g/L, between about 120 g/L to about 180 g/L, between about 120 g/L to about 160 g/L, between about 120 g/L to about 140 g/L, between about 140 g/L to about 200g/L, between about 140 g/L to about 180 g/L, between about 140 g/L to about 160 g/L, between about 160 g/L to about 200 g/L, between about 160 g/L to about 180 g/L, between about 180 g/L to about 200 g/L.

The formulation of the present technology may be fed once daily, twice, three time daily, four times daily, or as needed depending on the nutritional needs of the subject.

### EXAMPLES

### Example 1: Preparation of a Fortified Plant-Based Formulation for Children Between 12-24 Months Old

A fortified pant-based formulation for children between 12-24 months old was prepared by mixing organic hemp hearts powder, organic pea protein, organic coconut oil powder, organic rice milk powder, grounded organic flax seed, organic banana powder, marine calcium, fruit and veggie blend, sunflower lecithin powder and organic natural flavors in an industrial mixer, such that the final the amount of each vitamin, lipid, protein, calcium-source and carbohydrate components were 0.08 wt %, 11.1 wt %, 21 wt %, 2.1 wt %, and 51.2% respectively. 28 g of the dehydrated formulation, in powder, was added to 200 ml of water and shaken vigorously until the powder was dissolved.

### Example 2: Preparation of a Fortified Plant-Based Formulation for Children of Ages 24 Months Old and Older

A fortified pant-based formulation for children between 2-5 years old was prepared. by mixing organic hemp hearts powder, organic banana powder, organic pea protein, organic coconut oil powder, organic rice milk powder, organic maple sugar, quinoa sprouts, grounded organic flax seed, sunflower lecithin powder, marine calcium, fruit and veggie blend, and organic natural flavors in an industrial mixer, such that the final amount of each vitamin, lipid, protein, calcium-source and carbohydrate components were 0.09 wt %, 9.8 wt %, 25 wt %, 3 wt %, and 49.5 st % respectively. 28 g of the dehydrated formulation, in powder, was added to 200 ml of water and shaken vigorously until the powder was dissolved.

### Example 3: Preparation of a Fortified Plant-Based Formulation for Athletes

A fortified pant-based formulation for athletes was prepared by mixing pumpkin seed protein, hemp hearts powder, cocoa powder, coconut milk powder, acacia gum, guar gum, coconut water, sunflower lecithin, golden flax seeds, natural calcium and magnesium sources from Phymatolithon calcareum and/or Lithothamnium corrallioides, pectin, stevia, sea salt, beetroot, sour cherry, Japanese matcha, ashwaganda, astragalus, spinach, spirulina, ginseng, medicinal mushrooms mycelial biomass blend, astragalus root, moringa leaf powder, dandelion root, and natural flavors, in an industrial mixer, such that the final amount of each vitamin, lipid, protein, calcium-source and carbohydrate components were 0.02 wt %, 10% wt %, 47 wt %, 0.45 wt %, 24 wt % respectively. 30 g of the dehydrated formulation, in powder, was added to 200 ml of water and shaken vigorously until the powder was dissolved.

Variations and modifications will occur to those of skill in the art after reviewing this disclosure. The disclosed features may be implemented, in any combination and subcombinations (including multiple dependent combinations and subcombinations), with one or more other features described herein. The various features described or illustrated above, including any components thereof, may be combined or integrated in other systems. Moreover, certain features may be omitted or not implemented. Examples of changes, substitutions, and alterations are ascertainable by one skilled in the art and could be made without departing from the scope of the information disclosed herein.

It should be appreciated that the present technology is not limited to the particular embodiments described and illustrated herein but includes all modifications and variations falling within the scope of the present technology as defined in the appended claims.

1. A fortified plant-based formulation suitable for administration to a subject comprising:
a) at least one vitamin component;
b) at least one lipid component;
c) at least one protein component; and
d) at least one calcium-source component, wherein the at least one calcium-source component is an algae, and
wherein the at least one calcium-source component is present in the fortified plant-based formulation in an amount ranging from between about 0.5 to about 4 wt %.

2. The fortified plant-based formulation of claim 1, wherein the algae is red algae.

3. The fortified plant-based formulation of claim 2, wherein the red algae is of the class Rhodophyceae.

4. The fortified plant-based formulation of claim 3, wherein the Rhodophyceae is of the order Corallinale.

5. The fortified plant-based formulation of claim 4, wherein the Corallinale is a non-geniculate Coralline algae.

6. The fortified plant-based formulation of claim 5, wherein the non-geniculate Coralline algae is a rhodolith algae.

7. The fortified plant-based formulation of claim 6, wherein the rhodolith algae is selected from: Phymatolithon calcareum and Lithothamnium corrallioides.

8. The fortified plant-based formulation of claim 1, wherein the at least one calcium-source component further comprises magnesium.

9. The fortified plant-based formulation of claim 1, wherein the subject is a child.

10. The fortified plant-based formulation of claim 9, wherein the child is between 6 months old and 12 months old.

11. The fortified plant-based formulation of claim 9, wherein the child is between 12 months old and 24 months old.

12. The fortified plant-based formulation of claim 9, wherein the child is between 24 months old and older.

13. The fortified plant-based formulation of claim 1, wherein the vitamin component is selected from: biotin, riboflavin, thiamin, vitamin A, vitamin B-12, vitamin B-6, vitamin C, vitamin D, vitamin E, vitamin K, niacin, folate, and pantothenate.

14. The fortified plant-based formulation of claim 1, wherein the vitamin component is present in the fortified plant-based formulation in an amount ranging between about 0.02 and about 0.1 wt %.

15. The fortified plant-based formulation of claim 1, wherein the lipid component is selected from fats, oils, glycerides, phospholipids, and free fatty acids.

16. The fortified plant-based formulation of claim 1, wherein the lipid component is present in the fortified plant-based formulation in an amount ranging between about 5 and about 35 wt %.

17. The fortified plant-based formulation of claim 1, wherein the protein component is selected from a non-animal source.

18. The fortified plant-based formulation of claim 1, wherein the protein component is present in the fortified plant-based formulation in an amount ranging between about 10 and about 50 wt %.

19. The fortified plant-based formulation of claim 1, wherein the formulation further comprises a carbohydrate component.

20.-29. (canceled)

30. A method for providing a nutritional supplement to a subject, the method comprising feeding the fortified plant-based formulation as defined in claim 1 to a subject.
